(19) United States
(12) Patent Application Publication
(10) Pub. No.: US 2005/0081722 A1
(43) Pub. Date: Apr. 21, 2005

(54) Hand breading apparatus

(76) Inventor: Bartolomeo Roberto Gucciardi, East Meadow, NY (US)

Correspondence Address: Mr. Bartolomeo Gucciardi, 64 Corey Lane, East Meadow, NY, 11554, US

(21) Appl. No.: 10/688,674

(22) Filed: Oct. 20, 2003

(51) Int. Cl. A23B 4/02

(52) U.S. Cl. 99/494

(57) ABSTRACT

A hand held apparatus used for coating and tenderizing food products particularly meat, poultry, and fish. The apparatus is comprised of a foodstuff container attached to a convex shaped plate with a plurality of protruding convex shaped protrusions attached to the head of the convex shaped plate head. In addition, the convex shaped protrusions optionally contain a variable number of smaller protrusions whereby increasing the adhesion of foodstuff coating onto the surface of food products. The foodstuff container can be made to attach, detachable or permanently affixed, onto the back of the convex shaped plate whereby additional leverage and maneuverability for applying pressure is achieved as well as the convenience of a container of foodstuff is constantly in hand. In addition, the foodstuff container brim can be attached to a container lid lip thereby acting as a lid for a separate foodstuff container. In a second embodiment, the apparatus contains a detachable convex shaped lid whereby a conventional means for dispensing foodstuff is provided in addition to a comfortable surface when applying hand pressure as well as preventing spillage of foodstuff when in use and as a cover for the convex shaped press plate when in storage. By applying downward force, rocking, and rolling the apparatus in a spiral manner the apparatus will tenderize food and apply foodstuff coating in one step without requiring any other conventional means of applying foodstuff coating onto food.

### BACKGROUND

1. Field of Invention

The present invention relates to the hand held apparatuses in the field of food preparation, particularly to tenderizing and season coating of solid malleable foods such as, but not limited to, meat, poultry, and fish with foodstuff such as, but not limited to, breadcrumbs, spices, and herbs within a typical domestic kitchen.

2. Description of Prior Art

Foodstuff coatings are typically applied onto the outer surfaces of food to be prepared prior to cooking. The intention of foodstuff coating is to enhance the flavor of the food or to make it more palatable. Foodstuff coated food is typically a preliminary step prepared for a frying or baking process, such as, but not limited to, fried breaded chicken cutlets. It has been found that pressing additional foodstuff coating onto the outer surface of food provides an enhanced flavor of foodstuff as well as more tender pieces of food versus simple shaking and tumbling methods and mechanisms of coating food with foodstuff.

In a typical household kitchen the food coating process is a labor-intensive, tedious, and cumbersome task typically requiring several stations for each step of the food coating process. Generally, a typical household chef would require utensils such as several bowls to contain foodstuff coating, such as breadcrumbs, flour, or both as well as a binding agent such as water, milk, or eggs where the food is dredged in order to provide a better sticking surface. After the binding agent dredge the food needs to be coated with foodstuff by shake, tumble, and/or physical hand pressing. The fact that the process requires many utensils, an extraordinary amount of space, and an extraordinary amount of time and effort is the basis for this invention.

Many methods and devices have been proposed to tenderize meats or distribute more foodstuff coatings onto food. Some of these proposed methods and devices are elaborate not well suited for typical household use while others are limited in their use of coating foodstuff onto food.

For example, U.S. Pat. No. 6,223,651 teaches a simple tool for seasoning and tenderizing food that embeds seasonings beneath the outer surfaces of food. This apparatus is intended to be used much the same as a hand held tenderizer whereby the chef needs to continually embed the seasoning beneath the surface of the food using a tapping/pounding technique. The limitation of this device is that of simple food seasoning such as spices and herbs are inadequate for coating the food entirely. In fact, any device requiring pounding, such as a meat-tenderizing mallet, is inadequate for coating foodstuff. The pounding results in the expulsion of the seasoning outside of the head of the mallet head. In addition the foodstuff coating will normally be wedged in between protrusions of such apparatuses due to the small spacing in between protrusion points.

Meat tenderizers such as U.S. Pat. No. 4,380,850 involving a roller to avoid pounding meat achieves the results of tenderizing meat without pounding, but these devices simply address tenderizing meat by cutting fibers and connective tissues using blades or sharp instruments and are inadequate for coating food with foodstuff. Meat tenderizers such as U.S. Pat. No. 5,393,261 comprises of a top and bottom plate each having a plurality of protruding projections whereby the meat is placed in between the plates and pressed between the two plates. This device limits the mobility of any food coating that would need to be applied since it is a stationary device therefore making it a cumbersome tool for coating as well as seasoning meat.

Breading apparatuses such as U.S. Pat. Nos. 4,182,260, 5,020,427, or 6,000,320 are simply too large and elaborate for typical household use and are intended for more mass productions of food preparation.

Although each of the above inventions address the subject of food preparation and more particularly the preparation of meat, poultry, and fish there still remains a need to provide a quick, easy, and efficient method of tenderizing and coating food with foodstuff within a typical household kitchen.

### SUMMARY

The objective of this invention is provide a cheap, easy to use, easy to clean, easy to store, hand-held apparatus for tenderizing and coating solid malleable food particularly meat, poultry, and fish with foodstuff, particularly seasoned breadcrumbs, in a clean and efficient manner whereby enhancing the palatability of food while eliminating tasks and utensils in food preparation within a typical household kitchen.

Previous discoveries have shown that tenderization processes and methods have made the food, particularly meats, more palatable. Tenderization methods include pounding or crushing meat to break apart fibers and connective tissues within meat. By applying force onto meat such that the fibers and connective tissues are disrupted achieves the result of tenderized meat. The process of tenderization is normally a separate task in a food preparation process.

Also, it has been found that pressing foodstuff coating onto food enhances the flavor of the food versus simple shake methods, particularly with ordinary seasoned breadcrumbs, when the prepared food is cooked. The pressing of foodstuff results in more foodstuff coating applied to food whereby enhancing the flavor of food with foodstuff. The pressing action also crushes meat whereby resulting in a tenderization process while coating food with foodstuff.

Based on the discoveries and findings stated an apparatus has been invented to tenderize and coat food in one convenient step whereby enhancing the flavor of food with foodstuff and improving the process of coating food for a typical domestic kitchen. The apparatus is configured such that it provides an average adult individual to hold in hand an apparatus to press foodstuff coating onto meat, poultry, or fish whereby achieving meat tenderization and foodstuff coating. The apparatus avoids the need to hammer, perform separate tasks, food binding agents, provides cleaner, easier, and more effective leverage than conventional rollers, and fits in the hand of an average adult individual. The apparatus is configured such that it is comfortable, sanitary, and easy to use, clean, and store for a typical household chef.

### BRIEF DESCRIPTION OF DRAWINGS

FIG. 1 is a side view of the second and preferred embodiment of the apparatus where a separate foodstuff container lid is detached from the foodstuff container.

FIG. 2 is a side view of the second and preferred embodiment of the apparatus where a separate foodstuff container lid is attached to the foodstuff container.

FIG. 3 is a bottom end view of the convex shaped plate head with convex shaped protrusions and one pyramid shaped prong attached to each convex shaped protrusion.

FIG. 4 is a bottom end view of the convex shaped plate head showing one spiral roll traversal of the convex shaped plate head when being maneuvered.

FIG. 5 are cross-sectional views of the convex shaped circular head with convex shaped circular protrusions on top of the convex shaped circular head and pyramid shaped protrusions on top of the convex shaped circular protrusions when positioned at its left-most, center-most, and right-most position whereby illustrating a rocking motion.

FIG. 6 is a topical end view of the first embodiment of the apparatus without a lid and without a foodstuff container lid lip.

FIG. 7 is a bottom end view of the separate foodstuff container lid contained within the second and preferred embodiment.

FIG. 8 is a side view of the second and preferred embodiment of the apparatus with the foodstuff container lid detached and being assembled for storage in one of two methods.

FIG. 9 is a side view of the second and preferred embodiment of the apparatus assembled for storage using one configuration.

FIG. 10 is a side view of the first embodiment of the apparatus. This configuration also illustrates the second and preferred embodiment of the apparatus assembled for storage using a second configuration.

### DETAILED DESCRIPTION

FIG. 10 illustrates the first embodiment of the apparatus 11. The apparatus, when placed upside down, acts as a lid for a foodstuff container where the foodstuff container lid lip 18 attaches onto an appropriately sized foodstuff container. Generally, the apparatus would initially be filled with foodstuff such as, but not limited to, seasoned breadcrumbs, within the foodstuff container 15 through the foodstuff container opening 19 from its base 36 to the foodstuff container brim 40. In addition, the process of filling the foodstuff container 15 with foodstuff is not a requirement of the present invention, however, the conventional methods of applying foodstuff coating onto food, such as, but not limited to, a separate foodstuff container is required.

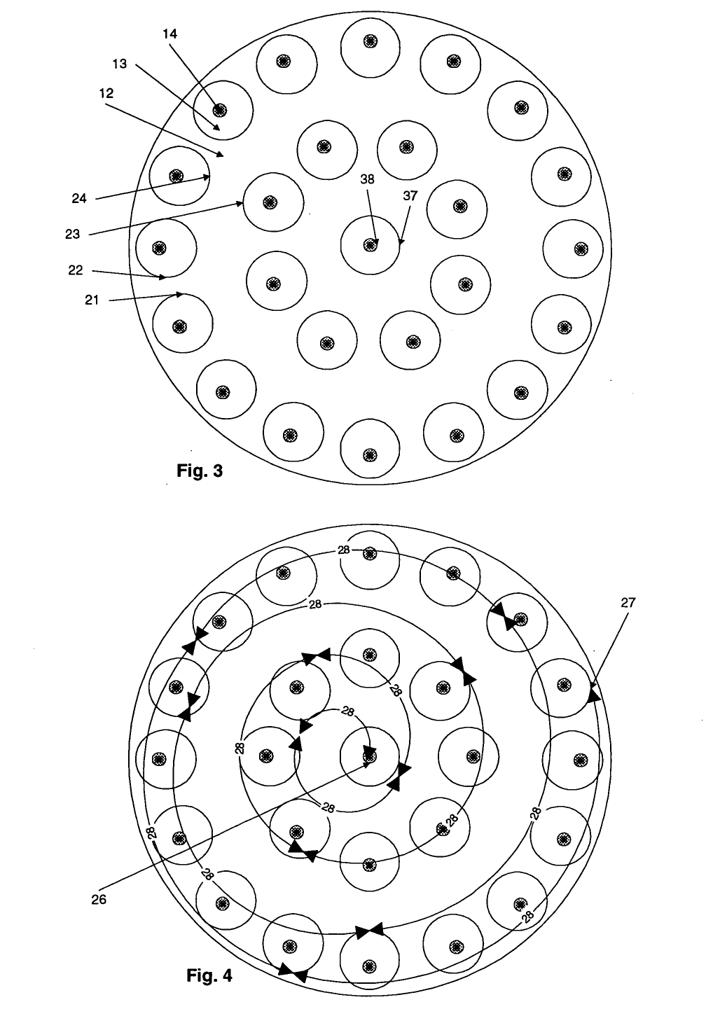

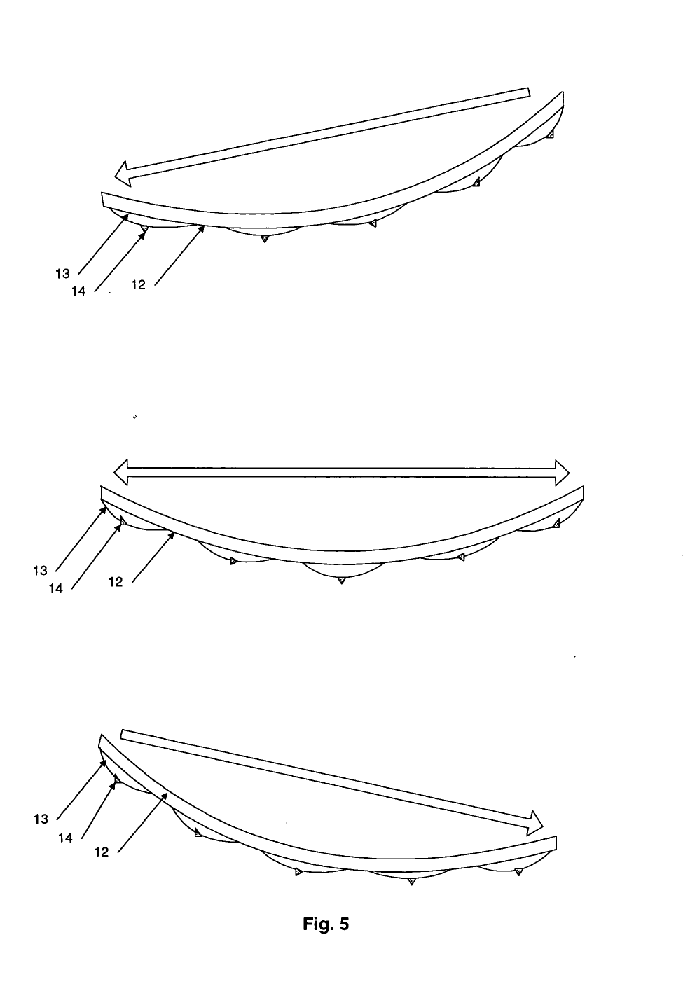

The chef will normally dislodge a layer of foodstuff over the foodstuff container brim 40 by tilting and shaking the apparatus 11, in an amount sufficient to coat the bottom of food within a bowl or breading pan. The food to be coated will normally be washed or dipped in egg to provide a better binding agent on to the surface of food but this invention does not require such a process to be performed thereby improving the typical process of coating food with foodstuff. The chef will then lay flat a piece of food, such as, but not limited to, a chicken cutlet, atop the center of foodstuff within the breading pan. The chef will normally sprinkle another layer of foodstuff atop the food, within the breading pan, such that it is completely surrounded with foodstuff. The chef will then take the apparatus 11 and place it centrally atop the coated food and apply downward pressure. With downward pressure being applied the chef, at their discretion, will roll the apparatus spirally 28 from its center 26 to its outer edge 27, as illustrated in FIG. 4, and rock the apparatus from its left-most edge, back through its center, to the right-most edge, and back to its left-most edge as illustrated in FIG. 5. The chef will continually pick up and place the apparatus 11 onto food and repeat the pressing process until food has been flattened whereby meat becomes tenderized and the food is entirely coated with foodstuff on its surface. In addition, the continued flattening of the food using the apparatus 11 expands the surface area of the food thereby increasing the overall amount of foodstuff coating applied to the outer surface of food.

FIG. 1 The second and preferred embodiment of the apparatus contains a separate foodstuff container lid 16 to be placed atop the foodstuff container opening 19 such that the foodstuff container lid lip 18 snugly fits over the foodstuff container brim 40, thereby enclosing 29 the foodstuff within the foodstuff container 15. The chef will normally dislodge a layer of foodstuff; through the foodstuff spout 17 by tilting and shaking the apparatus 11, in an amount sufficient to coat food as previously stated.

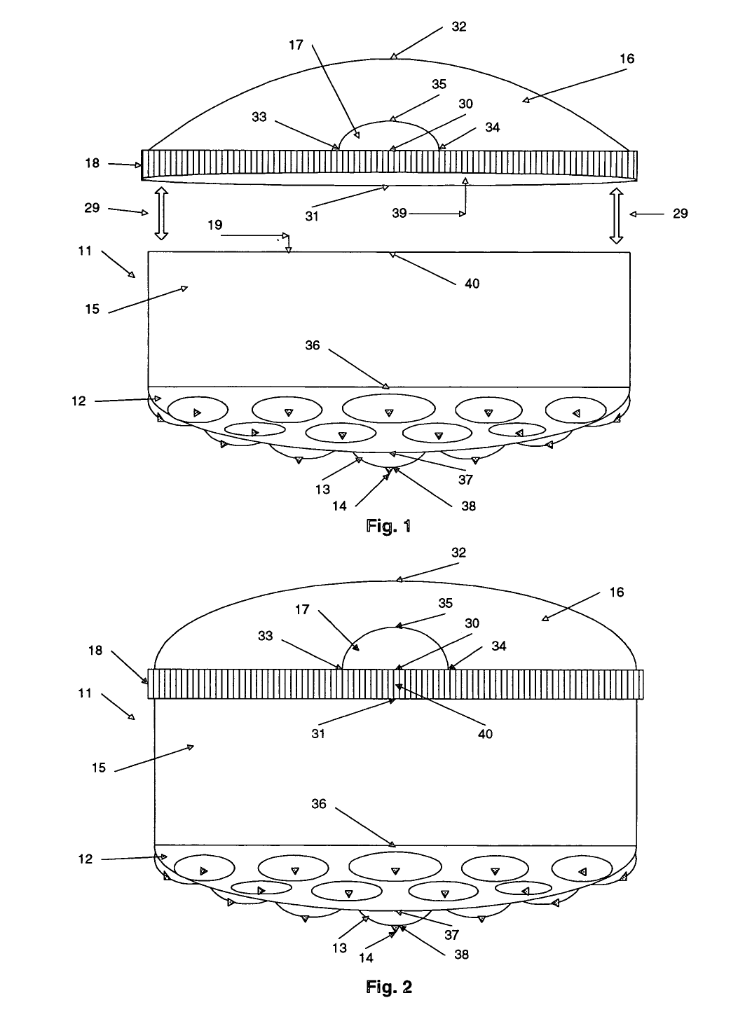

FIG. 2 is a side view of the apparatus 11, in its assembled form, for coating food with foodstuff encompassing the second and preferred embodiment of the present invention. The apparatus 11 is of a size that an average chef can grasp the foodstuff container lid 16, in one hand, where the chef's palm is centrally on top of the foodstuff container lid 16, fingers are over the foodstuff container lid lip 18, and foodstuff spout 17 is between the thumb and index fingers. The apparatus is of a weight, when foodstuff container 15 is filled with foodstuff, such that it can easily be manipulated by picking it up, tilting and shaking foodstuff through the foodstuff spout 17, and able to be maneuvered within a typical bowl or breading pan.

FIG. 1, according to the present invention the apparatus 11 can be made of any composition of matter not known to contaminate food and is of a construction as to withstand a moderate amount of downward pressure for a limited or indefinite period of time based upon usage and materials used for construction such as, but not limited to plastic, metal wood, or paper product. In a preferred embodiment, the foodstuff container 15, the convex shaped plate 12, the convex shaped protrusions 13, and the pyramid shaped prongs 14 can be manufactured from a form using a rigid plastic or metal for a durable hand breading apparatus 11 design. The preferred embodiment also can be manufactured by using a semi-rigid plastic or paper based construction for the foodstuff container 15 attached to, a semi-rigid formed convex shaped plate 12 with convex shaped protrusions 13 and optional pyramid shaped prongs 14, by any traditional means such as, but not limited to, adhesives, threads, and/or by interlocking designs for a temporary or disposable hand breading apparatus 11 design. In addition, the preferred embodiment would manufacture the convex shaped foodstuff container lid 16, foodstuff container lid lip 18, and foodstuff spout 17 from a second form. In the first embodiment, as illustrated in FIG. 10, the foodstuff container lid lip 18 would be formed with or attached onto the foodstuff container brim 40 whereby the foodstuff container lid 16 is not required to be manufactured.

FIG. 1, in a preferred embodiment, the foodstuff container 15 and convex shaped plate 12 will be circular and have a total diameter of approximately four inches. The height of the foodstuff container 15, from its bottom 36 to its top 40 will be approximately two inches. The convex shaped plate 12 will have a height of one half inch from its base 36 to its center 37. No particular size or shape is required according to the present invention, however, the convex shaped plate 12 and the plurality of convex shaped protrusions 13 are a requirement and the basis of this invention. In addition, no particular thickness of the foodstuff container 15, convex shaped plate 12, and plurality of convex shaped protrusions is required, however, the apparatus must be rigid to withstand a moderate amount of downward pressure for a limited period of time. In addition, the foodstuff container 15 is not a requirement of the present invention, however, any attachment, acting as a handle whereby providing leverage or maneuverability of the convex shaped plate 12 is a requirement.

FIG. 1, in its preferred embodiment, the foodstuff container lid 16 and foodstuff container lid lip 18 can be of any shape or size that can be conveniently be grasped in an average adults hand. The height of the foodstuff container lid 16 from its bottom 18 to its top 32 such that its height will approximately be the sum of heights of the convex shaped plate 12 plus the center-most convex shaped protrusion 13 plus the height of, if any, the center-most pyramid shaped protrusion 14. The total diameter of the foodstuff container lid 16 will be approximately the total diameter of the foodstuff container 15. The foodstuff spout 17 will be approximately three quarters of one inch in length from its right-most edge 33 to its left-most edge 34 and have a height of approximately one quarter of one inch from its base 30 to its top 35 where the foodstuff spout 17 is simply a semi-elliptical opening within the foodstuff container lid 16. The foodstuff container lid lip 18 will be approximately one quarter of one inch in total height starting from the bottom 31 to the top 30. In the preferred embodiment, the foodstuff container lid lip 18 will have an outer diameter slightly greater than the outer diameter of the foodstuff container 15 and is attached to the brim of the foodstuff container lid 16 by approximately one eight of one inch. In the first embodiment, the foodstuff container lid lip 18 will have an outer diameter of approximately one sixteenth of one inch wider than the outer diameter of the foodstuff container 15 and is attached to the foodstuff container brim 40 by approximately one eight of one inch. In either embodiment the foodstuff container lid lip 18 will be approximately one eight of an inch in thickness whereby it is attached to its respective item, the foodstuff container lid 16 or foodstuff container 15, by approximately one sixteenth of one inch. The foodstuff container lid 16 is not a requirement of the present invention. Explicitly stated here the foodstuff container 15 attached to the convex shaped plate 12 can also act as a foodstuff container lid such that a separate foodstuff container lid 16 is unnecessary to handle and operate the apparatus 11 in its preferred embodiment. FIG. 10 illustrates the first embodiment whereby the foodstuff container opening 19 represents that a separate lid is not present and can also act as a lid for a separate foodstuff container. FIG. 10 also illustrates the second embodiment whereby the foodstuff container lid opening 39 represents the presence of a lid in its stored configuration and can also act as a lid for a separate foodstuff container.

FIG. 3 is a bottom end view of a circular convex shaped plate 12 with a plurality of convex shaped circular protrusions 13 attached to the bottom of convex shaped circular head 12 and pyramid shaped protrusion 14 attached to the center of the convex shaped circular protrusions 13. In addition, FIG. 3 displays the spacing between the closest outer edges of convex shaped circular protrusions 13 when protrusions are on the same circular row such as items 21 and 22. FIG. 3 also depicts the spacing between the closest outer edges of convex shaped circular protrusions 13 when protrusions are on different circular rows such as items 23 and 24. The preferred embodiment would contain approximately twenty-five protruding circular convex shaped 13 each having a size of approximately one half of one inch in diameter where the height of the convex shaped protrusion from its base, the bottom of the convex press plate head 37, to its top-most point of convex shaped pressure point center 38, of approximately one quarter of one inch. The plurality of convex shaped protrusions 13 will be in a circular configuration with one protrusion at the center of the convex shaped plate 12, surrounded by a circular configuration of eight protrusions followed by a circular surrounding of sixteen protrusions around the eight protrusions. The distance between a convex shaped protrusion 21 and another convex shaped protrusion 22 on the same circular row should not be less than three sixteenths of one inch apart from the closest outer edges of each other on the same circular row. The distance between a convex shaped protrusion 23 and another convex shaped protrusion 24 should not be less than approximately one quarter of one inch apart from the closest edges of each other on different circular rows. The spacing between convex protrusions 13 and the curvature of the convex shaped plate 12 eradicates foodstuff from being lodged in between convex shaped protrusions 13, during foodstuff coating application. The convex shaped protrusions allow the convex shaped plate 12 to contain pressure points when downward force is applied, thus emulating about 25 fingers pressing foodstuff coating onto food in one spiral roll, as illustrated in FIG. 4. No particular number of protrusions, size, or shape is required according to the invention, however, the convex nature of the plate 12 and its convex shaped protrusions 13, are a requirement.

Using FIGS. 2 and 3, the pyramid shaped prongs 14 would be no greater than approximately one eight of one inch in diameter and one eight of one inch in height and is centrally located on each of the protruding convex shaped pressure points 38. The pyramid shaped prongs 14 are slightly rounded at its tip in order to prevent sharp points that may cause injury but not so rounded as to prevent its function of aiding in the embedment of foodstuff onto the surface of food. The total height of the convex shaped plate 12 from its bottom-most point 36 to its top-most point 14 is approximately seven eights of one inch. The number and shape of prongs 14 is not a requirement of the invention, however, any plurality of attached prong to the convex shaped plate 12 and/or protruding convex shaped pressure points 13 aiding in the embedment of foodstuff coating on to the surface of the food is preferred. In addition, the prong 14 are not intended to be driven into food, nor is it the specific purpose of tenderizing a meat product but rather to aid in the embedment of foodstuff onto the surface of food.

FIG. 4 is a bottom end view of the apparatus 11 having a convex shaped circular head 12 with a plurality of convex shaped circular protrusions 13 attached to the bottom of convex shaped circular head 12 and pyramid shaped protrusion 14 centrally attached to the bottom convex shaped circular protrusions 13. In addition, this view displays the full spiral roll traversal and tilted towards the left edge, indicated along the curved line with arrowheads 28, of the convex shaped circular head 12 when in use starting at position 26 and ending at position 27. The spiral roll traversal indicated along the curved line with arrowheads 28 can be implemented at the chef's discretion such as starting at any position between the center of the convex plate 26 and its outer edges 27. In addition, FIG. 5 illustrates a cross-sectional view of the rocking motion of the convex shaped plate 12 with convex shaped protrusions 13 and pyramid shaped protrusions 14 from left, to center, to right respectively when the apparatus is in use. The combination of FIGS. 4 and 5 illustrates the maneuverability of the convex shaped plate 12 and its convex shaped protrusions 13 when in use and the flexibility of application by the chef.

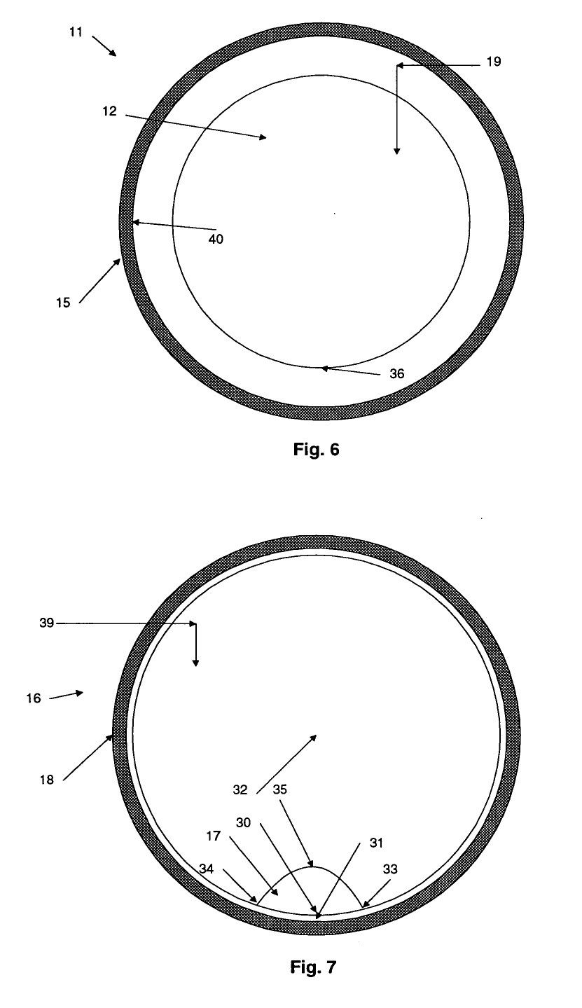

FIG. 6 is a topical end view of the second and preferred embodiment of the foodstuff container 15 without a convex shaped foodstuff container lid 16 depicted in other figures. FIG. 6 illustrates the inside of the circular shaped foodstuff container 19 where the circular shaped foodstuff container 15 is affixed to the back of convex shaped circular head 12. FIG. 7 illustrates a bottom end view the circular shaped foodstuff container lid 16 where the circular shaped foodstuff container lid lip 18 is affixed to the brim of a convex shaped circular lid 16.

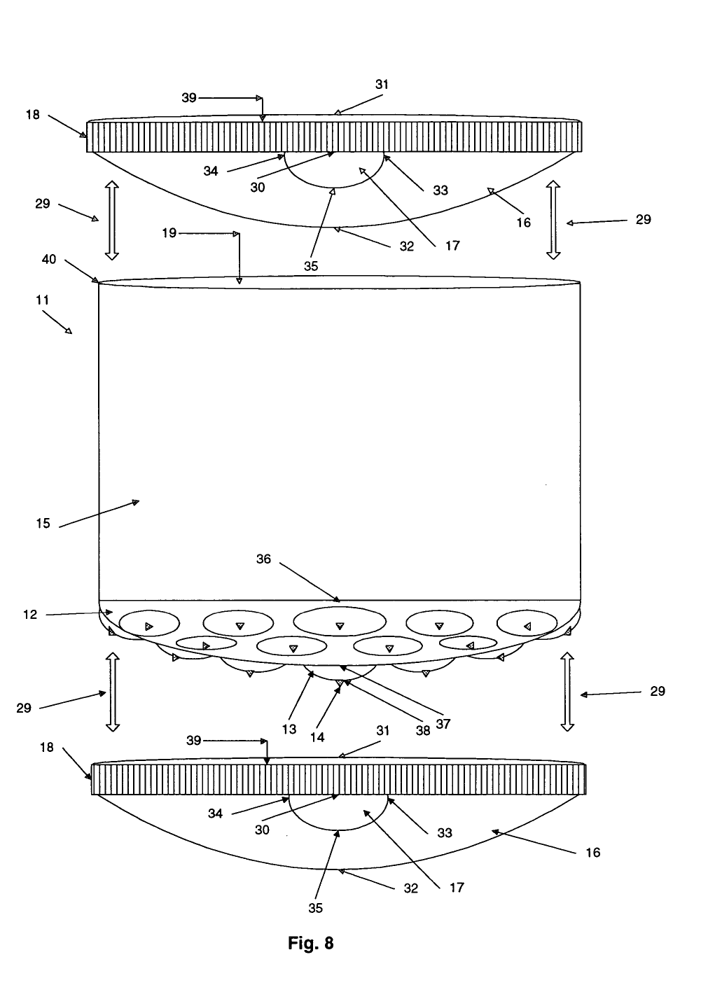

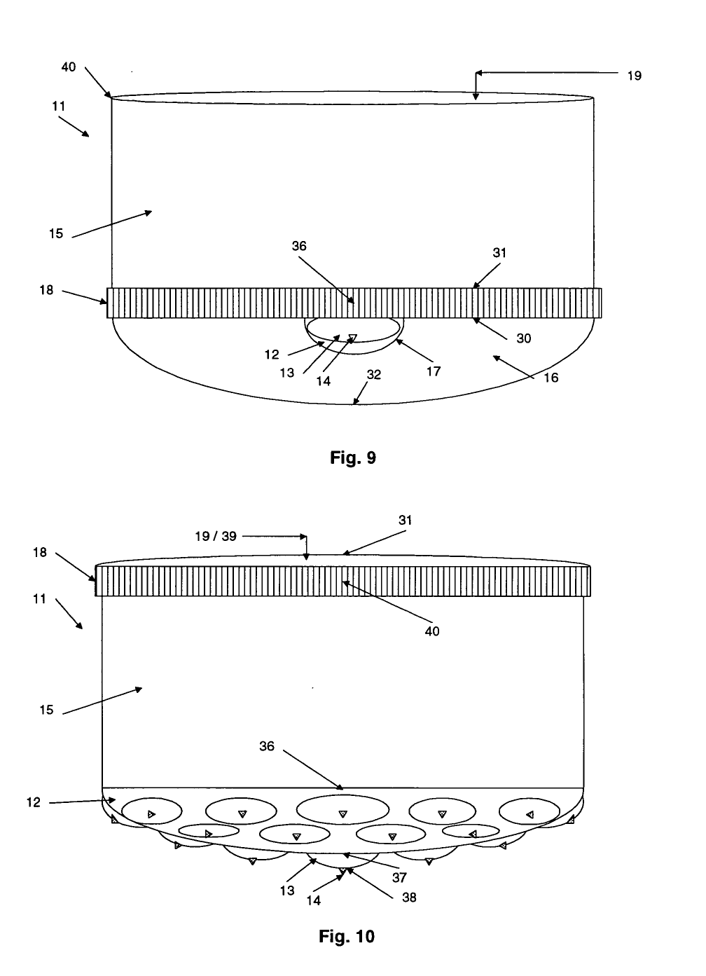

FIG. 8 illustrates the apparatus 11 being assembled for storage in one of two methods. This illustrations show how a chef would push/pull 29 the foodstuff container lid 16 onto/from the foodstuff container 15 whereby exposing the foodstuff container opening 19 and foodstuff container lid opening 39. Aligning the center of the foodstuff container lid 16 with the center of the foodstuff container 15 performs the assembly 29 of the apparatus for storage, as illustrated in FIGS. 9 and 10. The apparatus can easily be hand cleaned and dried by separating the foodstuff container 15 from the foodstuff container lid 16.

FIG. 9 illustrates one method of storage of the apparatus 11 whereby the foodstuff container lid 16 covers the convex shaped plate 12. The illustration shows the side view of the apparatus 11 assembled to be stored with the foodstuff container lid lip 18 attached to the bottom of the foodstuff container 36 whereby completely covering the convex shaped plate 12, its convex shaped protrusions 13, and the prongs 14. FIG. 9 also shows the foodstuff spout 17 is facing forward and a partial view of convex shaped plate 12, one of the convex shaped protrusions 13, and one of the prongs 14 is showing through the foodstuff spout 17. By turning the apparatus 11 upside down it can be placed on any flat surface. In its preferred embodiment the total height of the apparatus assembled for storage would be approximately three inches.

FIG. 10 illustrates, as previously stated, the first embodiment of the apparatus 11 whereby the foodstuff container lid lip 18 is attached to the brim of the foodstuff container 15. By turning the first embodiment of the apparatus 11 upside down it can be placed on any flat surface or atop a separate foodstuff container of an appropriate shape and diameter. FIG. 10 also illustrates a second method of storage of the second and preferred embodiment of the apparatus 11 whereby the foodstuff container lid 16 is placed upside down within the foodstuff container 15, exposing the foodstuff container lid opening 39. By turning the apparatus 11 upside down it can be placed on any flat surface or atop a separate foodstuff container of an appropriate shape and diameter.

It is to be understood that the present invention is by no means limited to the particular sizes, construction, and use herein disclosed, as shown in the drawings, but also comprises any modifications or equivalents within the scope of the claims.

1. A hand breading apparatus for use in association of coating food with foodstuff where foodstuff has been deposited on the outer surface of the food, the apparatus comprising:
a convex shaped plate having any size or shape configuration;
a plurality of convex shaped protrusions attached to the outer surface of said convex shaped plate acting as press points having any size or shape configuration;
an optional plurality of prongs attached to said convex shaped protrusions aiding in the embedment of foodstuff onto the outer surface of food having any size or shape;
an attachment such as, but not limited to, a foodstuff container, acting as a handle, having any size or shape configuration, to said convex shaped plate that provides leverage and maneuverability of said convex shaped plate.

2. An attachment such as, but not limited to, a foodstuff container lid lip, attached to said foodstuff container brim, as set forth in claim 1, such that said foodstuff container can also act as a lid for a separate foodstuff container

3. A foodstuff container lid having a foodstuff spout and a foodstuff container lid lip as a separate attachment to said apparatus as set forth in claim 1.

4. An apparatus according to claim 1 constructed using compositions of matter, not known to contaminate food products and is rigid to withstand a moderate amount of downward hand pressure, such as, but not limited to metals, plastics, wood, or paper products.

5. An apparatus according to claim 2 constructed using compositions of matter, not known to contaminate food products and is rigid to withstand a moderate amount of downward hand pressure, such as, but not limited to metals, plastics, wood, or paper products.

6. An apparatus according to claim 3 constructed using compositions of matter, not known to contaminate food products and is rigid to withstand a moderate amount of downward hand pressure, such as, but not limited to metals, plastics, wood, or paper products.
